(19) United States
(12) Patent Application Publication
(10) Pub. No.: US 2009/0124526 A1
(43) Pub. Date: May 14, 2009

(54) COMPOSITION FOR CLEANING HARD SURFACE

(76) Inventors: Geert Andre De Leersnyder, Wielsbeke (BE); Patrick Firmin August Delplancke, Laarne (BE); Marc Theophile Francois Evers, Strombeek-Bever (BE); Stefano Scialla, Rome (IT)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/270,320

(22) Filed: Nov. 13, 2008

(30) Foreign Application Priority Data
Nov. 13, 2007 (EP) 07 120 571.0

(51) Int. Cl. C11D 17/08

(52) U.S. Cl. 510/191; 510/406

(57) ABSTRACT

Compositions for cleaning hard surfaces wherein said compositions comprise two partial liquid compositions which are held separate form each other. Said compositions are particularly suitable for the cleaning of hard surfaces including toilet bowls and the likes.

### TECHNICAL FIELD

The present invention relates to compositions for cleaning hard surfaces wherein said compositions comprise two partial liquid compositions. Said compositions are particularly suitable for the cleaning of hard surfaces including toilet bowls and the like.

### BACKGROUND

A great variety of cleaning compositions have been described in the art. Indeed, compositions for cleaning hard surfaces, especially for hard surfaces found in bathrooms, such as sanitary fittings (e.g., toilet bowls), bathroom tiles, etc., are already known in the art.

Even though, the currently known compositions provide a good performance with regard to cleaning performance, it has been found by consumer research that the cleaning performance of the compositions can be further improved. More especially, it has been found that cleaning compositions applied onto a hard surface do not adhere sufficiently onto said hard surface. In particular, on more or less inclined hard surfaces, such as walls, shower cabins, bathtubs, toilet bowls and urinals, etc., hard surface cleaning compositions applied thereon have the tendency to run off in a short amount of time after the application. Such a limited adherence significantly reduces the time of exposure of said composition onto the surface and thus significantly reduces the cleaning performance.

The present invention addresses the above describe problem and provides a hard surface cleaning composition which has improved cleaning performance and that adheres for a prolonged period of time on a hard surface applied thereon. Indeed, the present invention provides a hard surface cleaning composition that clings well to the surface applied.

The present invention encompasses a liquid cleaning composition comprising two partial liquid composition which are held separate form each other, wherein the first composition is an alkaline composition, the second composition is an acidic composition and wherein the first and the second composition are combined together in view of obtaining a final composing having a pH under 4. An essential feature of the present invention is that the alkaline composition contains an effervescent agent.

In a preferred embodiment the composition of the present invention, the composition disclosed herein has a viscosity range comprised between 50 and 400 cps, preferably between 100-350 cps and even more preferably between 150 and 300 cps.

The compositions herein provide as an advantage a composition having a specific viscosity in the same time with an effervescent effect when applied onto a hard surface. Indeed, these compositions herein provide dense foam that clings well onto the hard surface applied upon and therefore provides excellent cleaning effect. Thus, an advantage of the present invention is that it provides an increased volume of foam when applied onto a hard surface to be treated. Indeed, the composition herein disclosed provides a lasting fizzing effect which results in the creation of a dense foam that clings well onto the treated hard surface.

Moreover, it has surprisingly been found that the composition of the present invention provides excellent cleaning performance when used on hard surface. Another advantage of the present invention is that the composition, due to the foaming effect, is more attractive and convenient to use by the consumers.

### Background Art

The following documents are representative of the prior art available on two parts hard surface cleaning compositions.

U.S. Pat. No. 6,583,103 relates to a liquid two part cleaning composition for hard surface wherein a least one of the liquid component includes a foam inhibitor.

WO 2005/093029 discloses a product comprising first and second compartment and a catalyst for a reaction between the two compartment, wherein the two compartment are combined together to form a cleaning composition.

US 2007/0004609 relates to an aqueous multicomponent system comprising a hydrophobic modified polymer which forms a high-viscosity liquid during mixing.

### SUMMARY OF THE INVENTION

The present invention encompasses a liquid cleaning composition comprising two partial liquid composition which are held separate form each other, wherein the first composition is an alkaline composition which contains an effervescent agent; the second composition is an acidic composition and wherein the first and the second composition are combined together in view of obtaining a composing having a pH under 4.

The present invention also encompasses a process for treating a hard surface by applying said composition and the use of said composition.

### DETAILED DESCRIPTION OF THE INVENTION

Composition

The composition of the present invention is formulated as a liquid composition. A preferred composition herein is an aqueous composition and therefore, preferably a liquid composition which comprises water, more preferably in an amount of from 10% to 99%, even more preferably of from 40% to 97% and most preferably 60% to 95% by weight of the total composition.

An essential characteristic of the present invention is that the composition comprises two partial liquid compositions which are held separate form each other.

The compositions in the first partial liquid composition comprise an acidic composition and the second partial liquid composition comprises an alkaline composition. In view of obtaining the composition of the present invention, the two partial compositions are mixed upon use to form the cleaning composition.

Thus, an essential feature of the present invention is that the first and the second composition are combined together in view of obtaining a composing having a pH under 4.

The pH of the combined liquid cleaning composition of the present invention may typically be from 0 to 4. Preferably, the pH of the cleaning compositions herein, as is measured at 25° C., is at least 0.1, with increasing preference in the order given, 0.1, 0.15, 0.2, 0.25, 0.3, or 0.4. Independently, the pH of the cleaning compositions herein, as is measured at 25° C., preferably is no more than 4, with increasing preference in the order given, 4, 3.5, 3, 2.5, 2, 1.75, 1.5, 1.25, 1, 0.75, 0.5, 0.45 or 0.4.

Another essential feature is that the first composition is an alkaline composition, meaning thus that the pH must be above 7. The pH of the alkaline composition may typically be from 7 to 14. Preferably, the pH of the alkaline compositions herein, as is measured at 25° C., is at least 7, with increasing preference in the order given, 14, 13, 12, 11, 10, 9, 8, and 7.

Another essential feature is that the first composition is an acidic composition, meaning thus that the pH must be below 4. The pH of the acidic composition may typically be from 0 to 7. Preferably, the pH of the acidic compositions herein, as is measured at 25° C., is at least 0.1, with increasing preference in the order given, 0.5, 1, 1.5, 1.5, 2, 2.5, 3, 3.5 and 4.

Acidity further contributes to formulate compositions of the present invention that exhibit good limescale removing performance whilst exhibiting also good disinfecting properties. Accordingly, the acidic compositions of the present invention may comprise organic and/or inorganic acids.

Particularly suitable acids to be used herein are aryl and/or alkyl sulfonate, such as methane sulfonic acids, citric acid, succinic acid, sulphamic acid, maleic acid, lactic acid and the like. Other suitable acids are sulfuric, phosphoric, hydrochloric, sulphamic, nitric, formic, citric acids and the like.

In a more preferred embodiment, the acid will be selected form the group constituting of phosphoric acid, hydrochloric acid, sulphamic acid, formic acid, lactic acid, citric acid and mixture thereof.

In another preferred embodiment the acid is of from 0.01% to 25%, preferably from 1% to 20% and more preferably from 2% to 15% by weight of the total final composition, i.e. the composition resulting form the addition of the both partial composition.

Bases can be used in the alkaline composition. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

An essential characteristic of the present invention is that the alkaline composition contains an effervescent agent. Indeed, an essential feature of the composition effervescence or fizzing effect is created upon mixing of the two partial compositions, i.e. upon mixing of the alkaline and of the acidic composition.

The effervescent system of the present invention can be any suitable effervescent system known to those skilled in the art.

Effervescency as defined herein means the evolution of bubbles of gas from a liquid, as the result of a chemical reaction between, for example, a soluble acid source and an alkali metal carbonate, to produce carbon dioxide gas.

“Effervescence” as used herein includes, but is not limited to, the formation of gas, gas bubbles, foam, mousse, etc. from the effervescent system as described herein.

Chemical and physical separation of the effervescent agent containing in the alkaline composition and the acidic composition is another essential feature of the present invention.

In a preferred embodiment, the effervescent agent of the alkaline composition is a bicarbonate and/or a carbonate salt.

In a more preferred embodiment, the effervescent agent is a bicarbonate salt or a mixture of carbonate/bicarbonate salt.

Suitable alkali and/or earth alkali inorganic carbonate salts herein include carbonate and hydrogen carbonate of potassium, lithium, sodium, and the like amongst which sodium and potassium carbonate are preferred. Suitable bicarbonates to be used herein include any alkali metal salt of bicarbonate like lithium, sodium, potassium and the like, amongst which sodium and potassium bicarbonate are preferred.

The inorganic alkali and/or earth alkali carbonate salt of the compositions of the invention comprises preferably a potassium or more preferably a sodium salt of carbonate and/or bicarbonate. Preferably, the effervescent agent is a mixture of a sodium salt of carbonate and of bicarbonate, or a salt of bicarbonate.

The level of the bases, in the final composition, including the level of carbonates, represents from 0.1% to 30%, preferably from 0.5% to 25%, more preferably from 1% to 10% by weight of the total final composition, i.e. the composition resulting form the addition of both partial compositions.

Suitable bases for use in the effervescent agent-containing component include, but are not limited to, carbonates, bicarbonates, sesquicarbonates and mixtures thereof. Preferably, the base is selected from the group consisting of sodium carbonate, potassium carbonate, lithium carbonate, magnesium carbonate, calcium carbonate, ammonium carbonate, mono-, di-, tri- or tetra-alkyl or aryl, substituted or unsubstituted, ammonium carbonate, sodium bicarbonate, potassium bicarbonate, lithium bicarbonate, ammonium bicarbonate, mono-, di-, tri- or tetra-alkyl or aryl, substituted or unsubstituted, ammonium bicarbonate and mixtures thereof. The most preferred bases are selected from the group consisting of sodium bicarbonate, monoethanolammonium bicarbonate and mixtures thereof. Preferably, the bases are water-soluble bases.

In the preferred embodiment, the compositions are thickened compositions; meaning thus that a feature of the cleaning composition of the present invention is that the final composition, obtained after mixing of the acidic and the alkaline composition, have a viscosity range comprised between 50 and 400 cps, preferably between 100 and 300 cps and more preferably between 150 and 250 cps.

In another preferred embodiment of the present invention the alkaline composition has a viscosity comprised between 50 and 400 cps, preferably between 100 and 350 cps and more preferably between 150 and 300 cps.

In another preferred embodiment of the present invention the acidic composition has a viscosity comprised between 50 and 400 cps, preferably between 100 and 350 cps and more preferably between 150 and 300 cps.

Preferred compositions have a viscosity of from 50 to 400 cps, and more preferably of from 100 to 350 cps at 20° C. All the measurements of viscosity are made using a Rheometer model AR 1000® (Supplied by TA Instruments) with a 4 cm conic and a truncation of 57 micrometer spindle in stainless steal (linear increment from 1 to 70 sec-1 in max. 8 minutes). All measurements of viscosity are measured at 30 sec-1. Every numerical range given throughout this specification will include every narrower numerical range that falls within such broader numerical range, as if such narrower numerical ranges were all expressly written herein.

It is at these preferred viscosities where the compositions herein show a good mixing effect. They also show good fizzing effect and good distribution of the composition over the surface to be cleaned as well as an adherence to said surface sufficient to stick to the surface during the cleaning operation itself. Furthermore, the rinsing-off of said composition of the surface after the cleaning is also beneficial.

The Process of Treating a Hard-Surface

In an another aspect, the present invention encompass a process of treating hard surface with the composition disclosed herein, wherein said process comprises the step of applying said composition onto said surface.

By “treating” it is meant herein, cleaning, as the composition of the present invention provides excellent cleaning performance on various stains.

The compositions are suitable to clean a hard surface. Any type of surface prone to soiling may be cleaned with the compositions herein. Preferably, the surfaces herein are hard-surfaces, more preferably hard-surfaces typically found in houses like kitchens, bathrooms, e.g., floors, walls, tiles, windows, cupboards, sinks, showers, shower plastified curtains, wash basins, toilet bowls, urinals, fixtures and fittings and the like made of different materials like ceramic, enamel, vinyl, no-wax vinyl, linoleum, melamine, glass, Inox®, Formica®, any plastics, plastified wood, porcelain, metal or any painted or varnished or sealed surface and the like.

In a highly preferred embodiment the surfaces herein are hard-surfaces found in bathrooms, such as tiles, sinks, showers, wash basins, toilet bowls, urinals, bath tubs, fixtures and fittings and the like made of different materials like ceramic, porcelain, enamel, glass, Inox®, Formica®, or metal and the like.

Even more preferably, the surfaces herein are toilet bowls and urinals, most preferably the inside portion of a toilet bowls and urinals.

Preferably, said process of cleaning a surface additionally comprises the steps of leaving said composition to act on said surface and subsequently removing said composition from said surface by rinsing it off, such as flushing a toilet.

The compositions of the present invention may be contacted to the hard-surface to be treated in its neat form or in its diluted form. Preferably, the composition is applied in its neat form.

By “in its neat form”, it is to be understood that the liquid compositions are applied directly onto the enamel surface to be treated without undergoing any dilution, i.e., the liquid compositions herein are applied onto the hard-surface as described herein. By “diluted form”, it is meant herein that said composition is diluted by the user with an appropriate solvent, typically with water. The composition is diluted prior use to a typical dilution level of 10 to 400 times its weight of water, preferably from 10 to 200 and more preferably from 10 to 100.

By “rinsing”, it is meant herein contacting the hard surface cleaned with the process of the present invention with substantial quantities of appropriate solvent, typically water, after the step of applying the liquid composition herein onto said hard surface.

In the process herein, said composition is applied onto said surface by conventional means known by the skilled person. Indeed, the composition may be applied by pouring or spraying said composition onto said surface. Alternatively, said composition may be applied using an appropriate implement, such as a mop or a cloth, soaked in the diluted composition herein. Furthermore, once applied onto said surface said composition may be agitated over said surface using an appropriate implement.

The composition can be, at least partially, left on said surface at the end of said process of cleaning said hard surface. The method is suitable for treating hard-surfaces located in bathrooms or in toilet, and particularly in toilet.

Thus, in a more preferred embodiment, the present invention encompasses a process of treating inclined surface, more especially toilet bowl by applying onto said incline surface a cleaning composition such as defined herein.

Two Compartment Dispenser

In a preferred embodiment, the compositions herein disclosed are packaged in multi-compartment or multi-compartments bottles, preferably a two compartments package or two compartments dispenser. In all such embodiments the key measure is that the reactants are combined only at the time of cleaning. The package is designed to keep the composition physically separated from each other prior to their use, i.e. in two components: in a first and in a second component.

Thus, the present invention is also directed to a two-compartments dispenser comprising a first compartment containing an alkaline composition which contains an effervescent agent; a second compartment containing an acidic composition; and dispenser means adapted to dispense the contents of the first compartment and of the second compartment onto a surface to form a mixture having a pH under 4 and a viscosity range comprised between 50 and 400 cps.

There are several ways of mixing the first and the second components. This mixing can be done within a mixing zone adjacent to the outlets of the first and second compartments or into a mixing chamber forming part of the container. The container can also be designed to issue separate first and second components of compositions which are mixed substantially only when contacting the surface to be treated or even, the container can be designed to allow the first and second components to be mixed during the stream of the products to the surface to be treated. In a preferred embodiment, the container is designed to mix the separate first and second components of compositions only when contacting the surface to be treated. In a more preferred embodiment, the first and second components are mixed during the stream of the products to the surface to be treated, so called an “in-flight” mixing.

This multi-compartment container can be a spray execution or a bottle with two nozzles at the end.

Containers suitable for use in this aspect of the invention are well known. According to the invention, the multi-compartments container has the form of a multi-compartments bottle or spray. Examples include two-compartments trigger sprays having a mechanical pumping action and side-by-side twin squeeze bottle chambers having simple narrowed nozzle outlets. In an even more preferred embodiment, the multi-compartment container herein is a multi-compartment bottle.

Various two compartment containers are available for dispensing two part cleaning systems as described above. Some example two compartment containers can be found in U.S. Pat. Nos. 6,223,942 and 6,325,229 and 5,954,213 and 5,862,949, PCT International Publication Number WO 02/22467 A1 and European Patent Application No. EP 1 153 881 A1. U.S. Pat. No. 5,252,312 discloses a dual bottle according to the preamble of claim 1.

Optional Ingredients

The liquid compositions of the present invention may comprise a variety of optional ingredients depending on the technical benefit aimed for and the surface treated. Suitable optional ingredients for use herein include radical scavengers, perfumes, other solvents, builders, buffers, bactericides, hydrotropes, stabilizers, bleaches, bleach activators, silicone polymer, enzymes, soil suspenders, brighteners, anti-dusting agents, dispersants, color change indicator, pigments and dyes.

If not specifically mentioned, these optional ingredients can be present either in the acidic composition or either in the alkaline composition.

Surfactants

The compositions of the present invention may comprise, as an optional ingredient, surfactants or mixtures thereof. Preferably the cleaning composition comprises surfactants.

In a more preferred embodiment, the composition, such as defined in the present invention, contains surfactants which are both in the acidic and alkaline compositions. Indeed it has been proved that the composition, when containing surfactants both in the acidic and alkaline compositions has better foaming performances.

All types of surfactants may be used in the present invention including nonionic, anionic, cationic, amphoteric or zwiterrionic surfactants. It is also possible to use mixtures of such surfactants without departing from the spirit of the present invention.

Accordingly, the compositions of the present invention comprise up to 30%, preferably of from 0.1% to 20%, more preferably of from 1% to 15%, and most preferably of from 1% to 10% by weight of the total composition of a surfactant, or mixtures thereof.

Suitable cationic surfactants to be used herein include derivatives of quaternary ammonium, phosphonium, imidazolium and sulfonium compounds. Preferred cationic surfactants for use herein are quaternary ammonium compounds wherein one or two of the hydrocarbon groups linked to nitrogen are a saturated, linear or branched alkyl group of 6 to 30 carbon atoms, preferably of 10 to 25 carbon atoms, and more preferably of 12 to 20 carbon atoms, and wherein the other hydrocarbon groups (i.e. three when one hydrocarbon group is a long chain hydrocarbon group as mentioned hereinbefore or two when two hydrocarbon groups are long chain hydrocarbon groups as mentioned hereinbefore) linked to the nitrogen are independently substituted or unsubstituted, linear or branched, alkyl chain of from 1 to 4 carbon atoms, preferably of from 1 to 3 carbon atoms, and more preferably are methyl groups.

In the preferred embodiment of the present invention where persulfate salts or mixtures thereof are used as sources of active oxygen, the quaternary ammonium compound is preferably a non-chloride/non halogen quaternary ammonium compound. The counterion used in said quaternary ammonium compounds are compatible with any source of active oxygen and are selected from the group of methyl sulfate, or methylsulfonate, and the like.

Particularly preferred to be used in the compositions of the present invention are trimethyl quaternary ammonium compounds like myristyl trimethylsulfate, cetyl trimethylsulfate and/or tallow trimethylsulfate. Such trimethyl quaternary ammonium compounds are commercially available from Hoechst, or from Albright & Wilson under the trade name EMPIGEN CM®.

Suitable amphoteric surfactants to be used in the compositions include amine oxides having the following formula R1R2R3NO wherein each of R1, R2 and R3 is independently a saturated substituted or unsubstituted, linear or branched alkyl groups of from 1 to 30 carbon atoms, preferably of from 6 to 30 carbon atoms, more preferably of from 10 to 20 carbon atoms, and most preferably of from 8 to 18 carbon atoms. Suitable amine oxides for use herein are preferably compatible with source of active oxygen. Preferred amine oxides for use herein are for instance natural blend C8-C10 amine oxides as well as C12-C16 amine oxides commercially available from Hoechst.

Suitable nonionic surfactants to be used herein are alkoxylated fatty alcohol nonionic surfactants that can be readily made by condensation processes that are well known in the art. Indeed, a great variety of such alkoxylated fatty alcohols are commercially available which have very different HLB values. The HLB values of such alkoxylated nonionic surfactants depend essentially on the chain length of the fatty alcohol, the nature of the alkoxylation and the degree of alkoxylation. Hydrophilic nonionic surfactants tend to have a high degree of alkoxylation and a short chain fatty alcohol, while hydrophobic surfactants tend to have a low degree of alkoxylation and a long chain fatty alcohol. Surfactants catalogues are available which list a number of surfactants including nonionics, together with their respective HLB values.

Accordingly, preferred alkoxylated alcohols for use herein are nonionic surfactants according to the formula RO(E)e(P)pH where R is a hydrocarbon chain of from 2 to 24 carbon atoms, E is ethylene oxide and P is propylene oxide, and e and p which represent the average degree of, respectively ethoxylation and propoxylation, are of from 0 to 24. The hydrophobic moiety of the nonionic compound can be a primary or secondary, straight or branched alcohol having from 8 to 24 carbon atoms. Preferred nonionic surfactants for use in the compositions are the condensation products of ethylene oxide with alcohols having a straight alkyl chain, having from 6 to 22 carbon atoms, wherein the degree of ethoxylation is from 1 to 15, preferably from 5 to 12. Such suitable nonionic surfactants are commercially available from Shell, for instance, under the trade name Dobanol® or from Shell under the trade name Lutensol®. These nonionics are preferred because they have been found to allow the formulation of a stable product without requiring the addition of stabilisers or hydrotropes. When using other nonionics, it may be necessary to add hydrotropes such as cumene sulphonate or solvents such as butyldiglycolether.

Suitable anionic surfactants herein include water soluble salts or acids of the formula ROSO3M wherein R is preferably a C10-C24 hydrocarbyl, preferably an alkyl or hydroxyalkyl having a C10-C20 alkyl component, more preferably a C12-C18 alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Preferred anionic surfactants useful herein include salts (including, for example, sodium, potassium, ammonium, and substituted ammonium salts such as mono-, di- and triethanolamine salts) of soap, C9-C20 linear alkylbenzenesulfonates, C8-C22 primary or secondary alkanesulfonates, C8-C24 olefinsulfonates, sulfonated polycarboxylic acids prepared by sulfonation of the pyrolyzed product of alkaline earth metal citrates, e.g., as described in British patent specification No. 1,082,179, C8-C24 alkylpolyglycolethersulfates (containing up to 10 moles of ethylene oxide); alkyl ester sulfonates such as C14-16 methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C12-C18 monoesters) diesters of sulfosuccinate (especially saturated and unsaturated C6-C14 diesters), acyl sarcosinates, sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH2CH2O)kCH2COO—M+ wherein R is a C8-C22 alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23.

Preferred anionic surfactants for use in the compositions herein are the alkyl benzene sulfonates, alkyl sulfates, alkyl alkoxylated sulfates, and mixtures thereof.

Thickening System

The compositions herein may comprise a thickener or a thickening system as a highly preferred optional ingredient.

Suitable thickeners herein are selected from the group consisting of organic thickeners and inorganic thickeners and mixtures thereof, preferably organic thickeners, more preferably polysaccharides, and most preferably xanthan gum. Suitable thickening systems are selected from the group consisting of a cationic/anionic surfactant system self-thickening systems. For the acidic phase, an ethoxylated amine will be a preferred ingredient. Preferably, the compositions herein comprise xanthan gums as a thickener.

The compositions of the present invention may comprise from 0.05% to 15%, preferably from 0.05% to 10%, more preferably from 0.05% to 5% by weight of the total composition of a thickener or a thickening system.

Depending on the end use envisioned, the compositions may further comprise a variety of other ingredients including dyes, solvents, optical brighteners, builders, chelants, pigments, solvents, buffering agents, radical scavengers, polymers, stabilizers and the like.

Solvent

The composition of the present invention further comprises a glycol ether solvent or a mixture thereof. Typically, the compositions of the present invention comprise from 0.1% to 5% by weight of the total composition of a glycol ether solvent or mixtures thereof, preferably from 0.5% to 5% by weight of the total composition and more preferably from 1% to 3% by weight of the total composition.

Suitable glycol ether solvents for use herein include glycols having at least an ether function. Preferably it includes ethers and diethers having from 4 to 14 carbon atoms, preferably from 6 to 12 carbon atoms, and more preferably from 8 to 10 carbon atoms, glycols or alkoxylated glycols, C6-C16 glycol ethers and mixtures thereof. All glycol disclosed herein will have to contain at least an ether function.

Suitable glycols ether to be used herein are according to the formula R—O-(A)n-R1-OH wherein R is a alkyl of from 1 to 20 carbon atoms, preferably from 2 to 15 and more preferably from 2 to 10, wherein R1 is H or a linear saturated or unsaturated alkyl of from 1 to 20 carbon atoms, preferably from 2 to 15 and more preferably from 2 to 10, and A is an alkoxy group preferably ethoxy, methoxy, and/or propoxy and n is from 1 to 5, preferably 1 to 2. Suitable glycol ether are, for example, propylene/ethylene glycol ethyl/methyl ether; di- or tri-propylene/ethylene glycol ethyl/methyl ether, propylene/ethylene or di- or tri-propylene/ethylene glycol methyl ether acetate, propylene/ethylene phenol ethyl/methyl/butyl ether or mixture thereof. Other suitable solvents include butyl diglycol ether (BDGE), butyltriglycol ether, ter amilic alcohol and the like. Particularly preferred solvents to be used herein are butoxy propoxy propanol, butyl diglycol ether, butoxypropanol and mixtures thereof. The preferred solvent for use herein is butoxy propoxy propanol (n-BPP).

Radical Scavenger

The compositions of the present invention may comprise a radical scavenger or a mixture thereof. Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®. Radical scavengers when used, are typically present herein in amounts up to 10% by weight of the total composition and preferably from 0.001% to 0.5% by weight. The presence of radical scavengers may contribute to the chemical stability of the acidic compositions of the present invention.

Bleach

The compositions of the present invention may comprise, as an optional ingredient, bleach. Preferably, said bleach is selected from the group consisting of sources of active oxygen, hypohalite bleaches and mixtures thereof.

The bleach, preferably the source of active oxygen acts as an oxidising agent, it increases the ability of the compositions to remove colored stains and organic stains in general, to destroy malodorous molecules and to kill germs. In a preferred embodiment said bleach is a source of active oxygen or a mixture thereof.

Suitable sources of active oxygen for use herein are water-soluble sources of hydrogen peroxide including persulfate, dipersulphate, persulfuric acid, percarbonates, metal peroxides, perborates, persilicate salts, and mixtures thereof, as well as hydrogen peroxide, and mixtures thereof. As used herein a hydrogen peroxide source refers to any compound that produces hydrogen peroxide when said compound is in contact with water. In addition, other classes of peroxides can be used as an alternative to hydrogen peroxide and sources thereof or in combination with hydrogen peroxide and sources thereof. Suitable classes include dialkylperoxides, diacylperoxides, preformed percarboxylic acids, organic and inorganic peroxides and/or hydroperoxides. Suitable organic or inorganic peracids for use herein are selected from the group consisting of: persulphates such as monopersulfate; peroxyacids such as diperoxydodecandioic acid (DPDA) and phthaloyl amino peroxycaproic acid (PAP); magnesium perphthalic acid; perlauric acid; perbenzoic and alkylperbenzoic acids; and mixtures thereof. Suitable hydroperoxides for use herein are selected from the group consisting of tert-butyl hydroperoxide, cumyl hydroperoxide, 2,4,4-trimethylpentyl-2-hydroperoxide, di-isopropylbenzene-monohydroperoxide, tert-amyl hydroperoxide and 2,5-dimethyl-hexane-2,5-dihydroperoxide and mixtures thereof. Such hydroperoxides have the advantage to be particularly safe to carpets and carpet dyes while delivering excellent bleaching performance. Persulfate salts, or mixtures thereof, are the preferred sources of active oxygen to be used in the compositions according to the present invention. Preferred persulfate salt to be used herein is the monopersulfate triple salt. One example of monopersulfate salt commercially available is potassium monopersulfate commercialized by Peroxide Chemie GMBH under the trade name Curox®. Other persulfate salts such as dipersulphate salts commercially available from Peroxide Chemie GMBH can be used in the compositions. The compositions may comprise from 0.1% to 30%, preferably from 0.1% to 20%, more preferably from 1% to 10%, and most preferably from 1% to 7% by weight of the total composition of said bleach.

Perfumes

The compositions of the present invention may comprise, as an optional ingredient, a perfume ingredient preferably selected from the group consisting of: a cyclic terpene/sesquiterpene perfume, such as eucalyptol, cedrol, pinocarveolus, sesquiterpenic globulul alcohol; linalo; tetrahydrolinalo; verdox(cyclohexadiyl 2 tetryl butyl acetate); 6,3 hexanol; and citronellol and mixtures thereof.

Suitable perfumes for use herein include materials which provide an olfactory aesthetic benefit and/or cover any “chemical” odour that the product may have.

The compositions may comprise from 0.01% to 10%, preferably from 0.01% to 5%, more preferably from 0.01% to 2%, and most preferably from 0.1% to 1% by weight of the total composition of said perfume ingredient.

Dye

The liquid compositions may be coloured. Accordingly, they may comprise a dye or a mixture thereof. Suitable dyes for use herein are acid-stable dyes. By “acid-stable”, it is meant herein a compound which is chemically and physically stable in the acidic environment of the compositions herein.

The invention is further illustrated by the following examples. The following examples are meant to exemplify compositions used in process of the present invention but are not necessarily used to limit or otherwise define the scope of the present invention.

### EXAMPLES

The following examples illustrate the present invention. The compositions are made by combining the listed ingredients in the listed proportions. All the compositions below comprise water up to 100%. Furthermore, all percentages, ratios and proportions herein are by weight, unless otherwise specified.

Formula A

| | Compartment A | Compartment B |
|---|---|---|
| Xanthan gum | 0.4 | 0.35 |
| Phosphoric acid | 11 | — |
| Lactic Acid | 1 | — |
| Formic Acid | 1.8 | — |
| Dobanol 91-8 ® | 0.8 | 0.8 |
| Witconate NAS-8 ® | 0.6 | 0.6 |
| C12-14 Amine oxide | 0.2 | 0.2 |
| Sodium bicarbonate | — | 7.5 |
| Perfume | 0.6 | 0.60 |
| Dye | 0.005 | — |
| pH | 0.5-1.0 | 8.0-8.5 |
| Viscosity (in cps @ 30 sec−1) | ±130 | ±130 |

Formula B

| | Compartment A | Compartment B |
|---|---|---|
| Xanthan gum | 0.52 | 0.42 |
| Hydrochloric acid | 10 | — |
| Dobanol 91-8 ® | — | 1 |
| C7-9Alkyl sulphate | — | 2 |
| Sodium carbonate | — | 0.5 |
| Sodium bicarbonate | — | 6.5 |
| Preservative | — | 0.025 |
| Perfume | — | 0.7 |
| Dye | — | 0.005 |
| pH | 0-0.5 | 8.0-8.5 |
| Viscosity (in cps @ 30 sec−1) | ±200 | ±200 |

Formula C

| | Compartment A | Compartment B |
|---|---|---|
| Xanthan gum | 0.68 | 0.50 |
| Hydrochloric acid | 10 | — |
| Lactic Acid | 2 | — |
| Dobanol 91-8 ® | — | 1 |
| Witconate NAS-8 ® | — | 2 |
| Sodium bicarbonate | — | 7.5 |
| Preservative | — | 0.025 |
| Perfume | — | 0.70 |
| Dye | — | 0.0025 |
| pH | 0-0.5 | 8.0-9.0 |
| Viscosity (in cps @ 30 sec−1) | ±250 | ±250 |

Formula D

| | Compartment A | Compartment B |
|---|---|---|
| EthomeenT12 ® | 3 | — |
| Polysurf ® | — | 0.75 |
| Hydrochloric acid | 10 | — |
| C8 Amine oxide | — | 1.00 |
| Sodium bicarbonate | — | 7.5 |
| NaCl | 1.0 | — |
| Bardac ® 208M | 0.75 | 1.32 |
| Perfume | — | 0.70 |
| Dye | — | 0.002 |
| pH | 0.5-1.0 | 8.0-8.50 |
| Viscosity (in cps @ 30 sec−1) | ±300 | ±300 |

Xanthan gum is Kelzan ASX-T ® , commercially available from CpKelco.
EthomeenT12 ® is bis-(2hydroethyl) tallow-alkylamine, commercially available from AkzoNobel.
Polysurf ® is a cetyl-hyroxyethylcellulose available from Hercules.
Phosphoric acid is purchased from J. T. Baker.
Dobanol 91-8 ® is a C 9-11 EO8 nonionic surfactant available from Shell.
Witconate NAS-8 ® is Octyl-sulphonate (C8SO3) available from Witco.
Bardac ® 208M is an anti-bacteria agent commercially available from Lonza.

Example compositions A to D are packed in two-compartment dispensers and applied onto a partially inclined hard surface, such as toilet bowl. The compositions exhibit excellent adherence on said hard surface, provide dense and long lasting foam in addition to excellent cleaning performances.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid cleaning composition comprising two partial liquid compositions which are held separate from each other, wherein:
a. the first composition is an alkaline composition which contains an effervescent agent;
b. the second composition is an acidic composition;
and wherein the first and the second compositions are combined together to obtain a cleaning composing having a pH under 4.

2. The composition of claim 1, wherein the effervescent agent is selected from the group consisting of: a bicarbonate salt, a carbonate salt, and mixtures thereof.

3. The composition of claim 1, wherein the cleaning composition has a viscosity range comprised between 100 and 350 cps.

4. The composition of claim 1, wherein the alkaline composition has a viscosity range comprised between 100 and 350 cps.

5. The composition of claim 1, wherein the acidic composition has a viscosity range comprised between 100 and 350 cps

6. The composition of claim 1, wherein the cleaning composition further comprises thickeners.

7. The composition of claim 1, wherein the cleaning composition further comprises surfactants which are both in the acidic and the alkaline compositions.

8. The composition of claim 1, wherein the composition is packaged in a two-compartment dispenser.

9. The composition of claim 1, wherein the cleaning composition further comprises ingredient selected form the group consisting of building agent, bleaching agent, chelating agents, dye, polymers, brighteners, perfumes, color change indicator and mixtures thereof.

10. A two-compartments dispenser comprising:
a) a first compartment containing an alkaline composition and an effervescent agent;
b) a second compartment containing an acidic composition;
c) and dispenser means adapted to dispense the contents of the first compartment and of the second compartment onto a surface to form a mixture having a pH under 4 and a viscosity range comprised between 50 and 400 cps.

11. The two-compartment dispenser of claim 11, wherein the resulting mixture is a fizzing composition.

12. A process of treating hard surfaces by applying the composition of claim 1 onto inclined hard surface.

13. The process of treating hard surfaces of claim 13, wherein said hard surface are toilet bowls or urinals.

14. A method of having an excellent fizzing effect and an excellent cleaning on inclined hard surface comprising providing the composition of claim 1 to said hard surface.
